(19) United States
(12) Patent Application Publication
(10) Pub. No.: US 2005/0046146 A1
(43) Pub. Date: Mar. 3, 2005

(54) Steerable trailer assembly

(76) Inventor: Jean-Paul Plante, St-Etienne (CA)

Correspondence Address: Mr. Jean-Paul Plante, 22 Des Chenes, St-Etienne, QC, C6J 1L6, CA

(21) Appl. No.: 10/652,934

(22) Filed: Sep. 2, 2003

(51) Int. Cl. B60D 1/00

(52) U.S. Cl. 280/460.1; 280/443

(57) ABSTRACT

A steerable trailer assembly allowing the directional movement of the wheels.

### BACKGROUND OF THE INVENTION

1. Field of the Invention

The present invention relates to a steerable trailer assembly allowing the directional movement of the wheels.

2. Description of the Related Art

A search of prior art records has unveiled the following patents:
1. CA U.S. Pat. No. 1,289,986 issued in 1991 to Winklder;
2. CA U.S. Pat. No. 384,283 issued in 1984 to Mergen;
3. CA U.S. Pat. No. 2,152,245 enregistered in 1995 to Chagnon; and
4. U.S. Pat. No. 4,955,630 issued in 1990 to Ogren.

The patents mentioned above are probably the most relevant,

### SUMMARY OF THE INVENTION

The gist of the invention is therefore to provide a trailer with a system allowing the directional movement of the wheels.

In accordance with the teachings of the present invention, there is disclosed a trailer including two directional wheels, a cable mounted to the structure of a tow bar and connected to an electric motor for activating a longer part member making turn the directional wheels, which the longer part member is joined to the electric motor by a smaller part member, and which are connected by the use of bolts and nuts.

A wheel support is mounted approximately in a middle of a front structure of the trailer.

An elongated rod is provided of a fastening means at each end for connecting a camber angle that is engaged to a caster connected to a directional wheel, and which each camber angle is also connected to a central part member by the use of a smaller connecting rod.

A chock absorber is connected at one end of the elongated rod by the use of bolts and nuts, or other conventional fastenings means to the central part member, which prevents the vibration movement of the elongated rod connected to the cambers angle.

Two leaf springs are mounted to the structure of the trailer, which a center portion of each leaf spring is maintained by a plate and a part member that are connected by the use of bolts and nuts, and which are joined to the central part member by a connecting rod allowing the movement of each leaf spring.

### BRIEF DESCRIPTION OF THE SEVERAL VIEWS OF THE DRAWING(S)

FIG. 1 shows a perspective top view of a steerable trailer assembly;

FIG. 2 shows a perspective bottom view thereof;

FIG. 3 shows a plan bottom view thereof;

FIG. 4 shows a bottom view showing the wheels turning towards the left of the trailer;

FIG. 5 shows a bottom view showing the wheels turning towards the right of the trailer;

FIG. 6 shows a plan rear view of the steerable trailer assembly;

FIG. 7a shows a perspective top view of the steerable trailer assembly showing the wheels turning towards the left of the trailer;

FIG. 7b shows a perspective top view of the steerable trailer assembly showing the wheels turning towards the right of the trailer;

FIG. 8 shows an exploded view of the steerable trailer assembly including the structure; and

FIG. 9 shows an exploded view of the steerable trailer assembly.

FIGS. 10a, 10b show the interconnecting structure between the longer part member and the axle/wheel assembly so as to manipulate the wheels to turn in two directions.

FIG. 11a, 11b show a plan view of the interconnecting structure between the longer part member and the axle/wheel assembly so as to manipulate the wheels to turn in two directions.

### DETAILED DESCRIPTION OF THE INVENTION

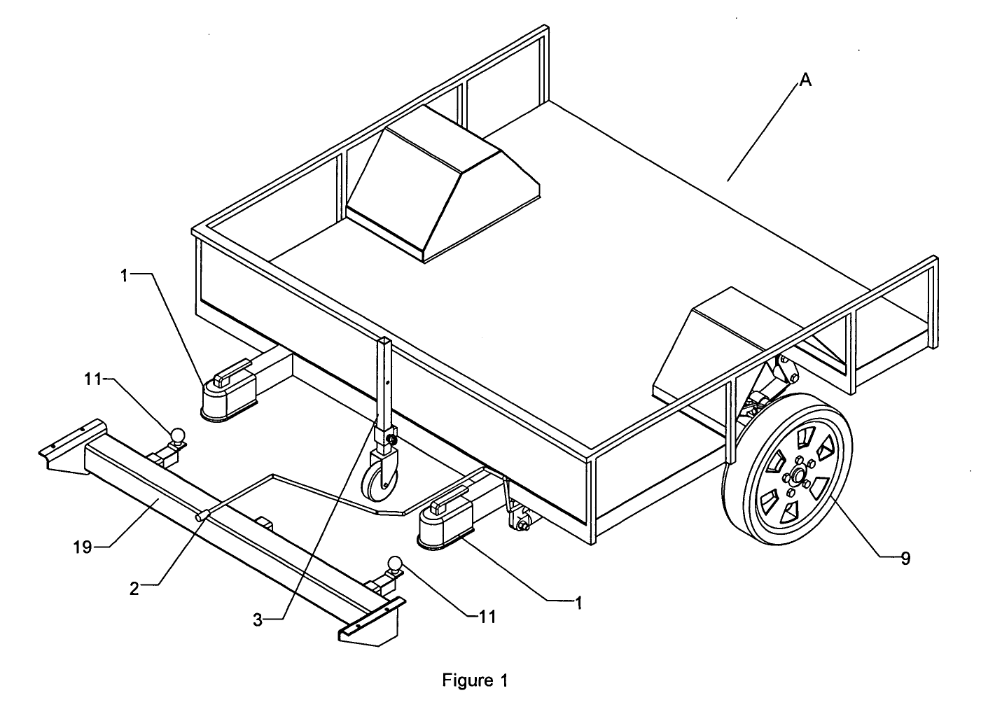

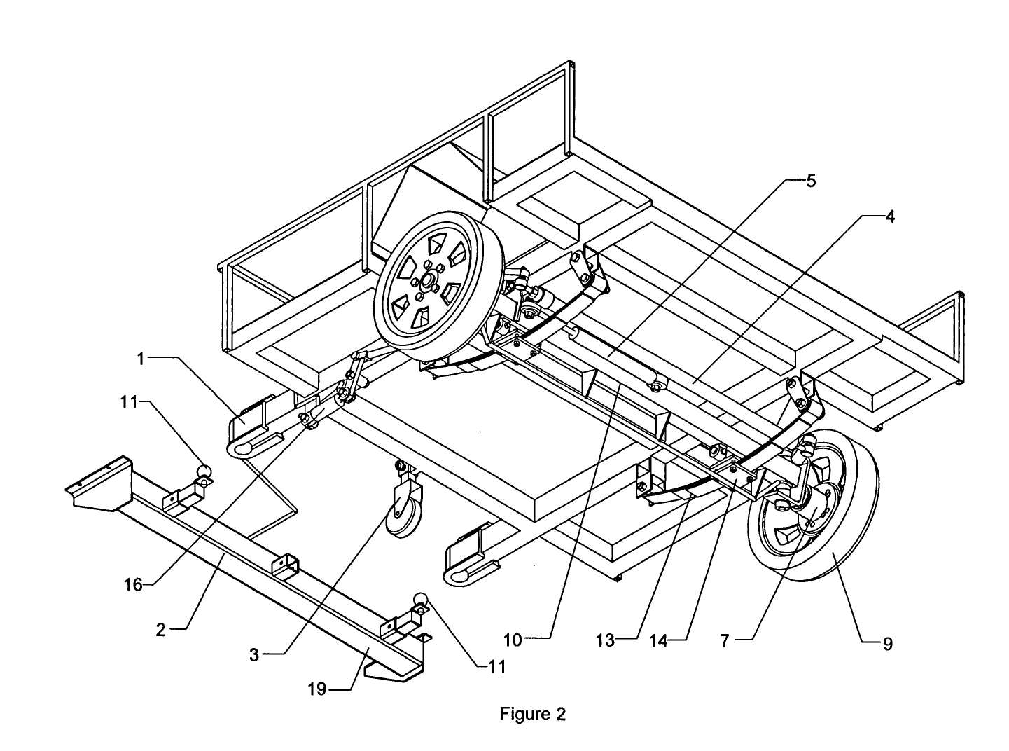

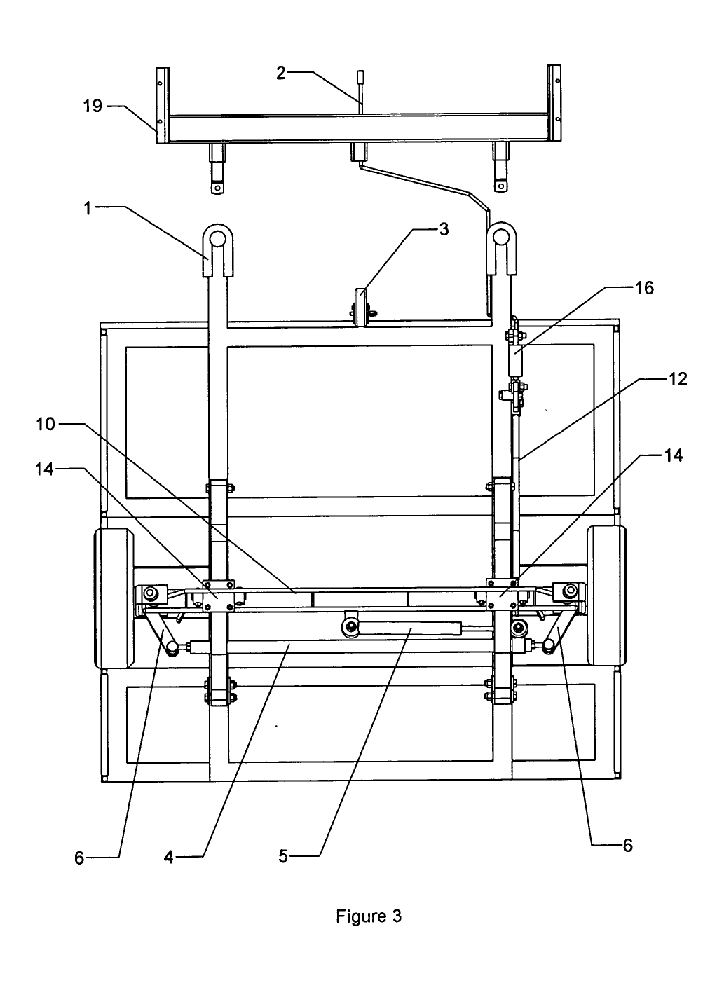

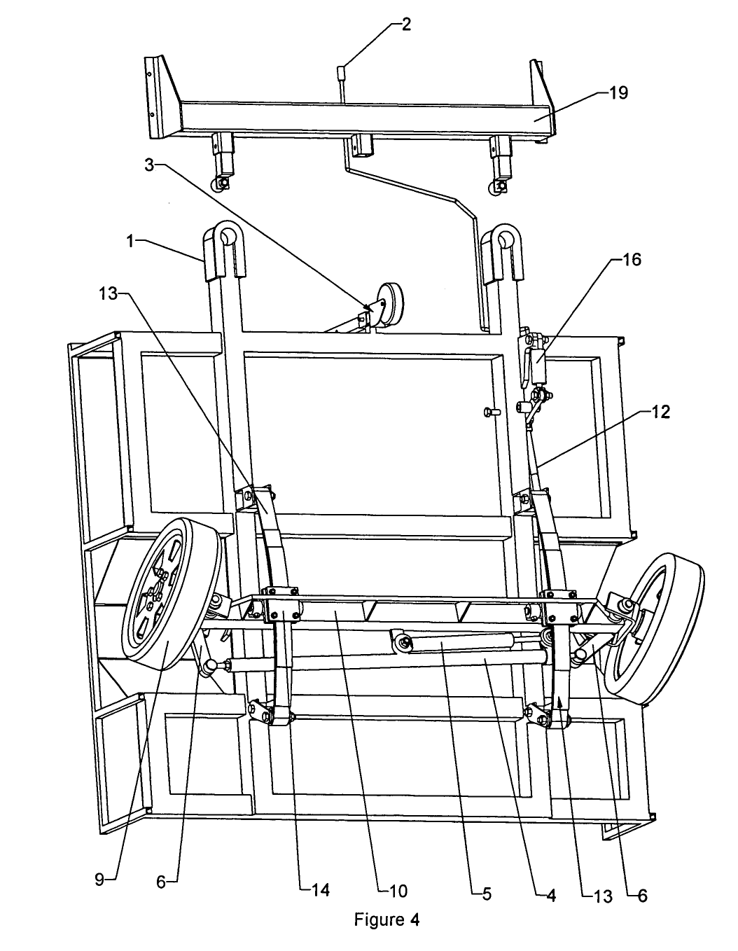

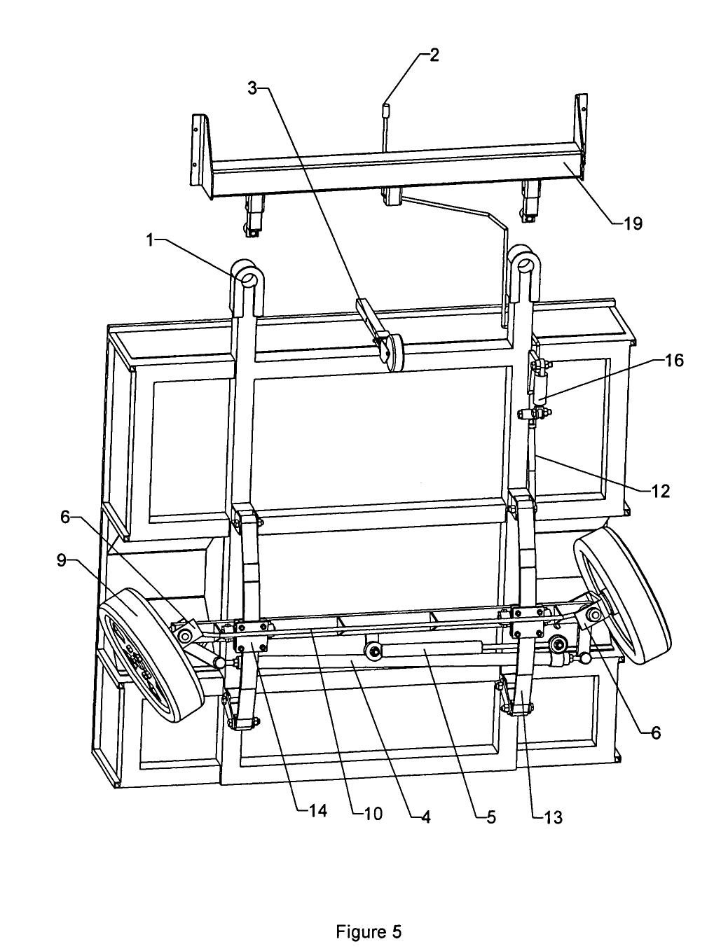

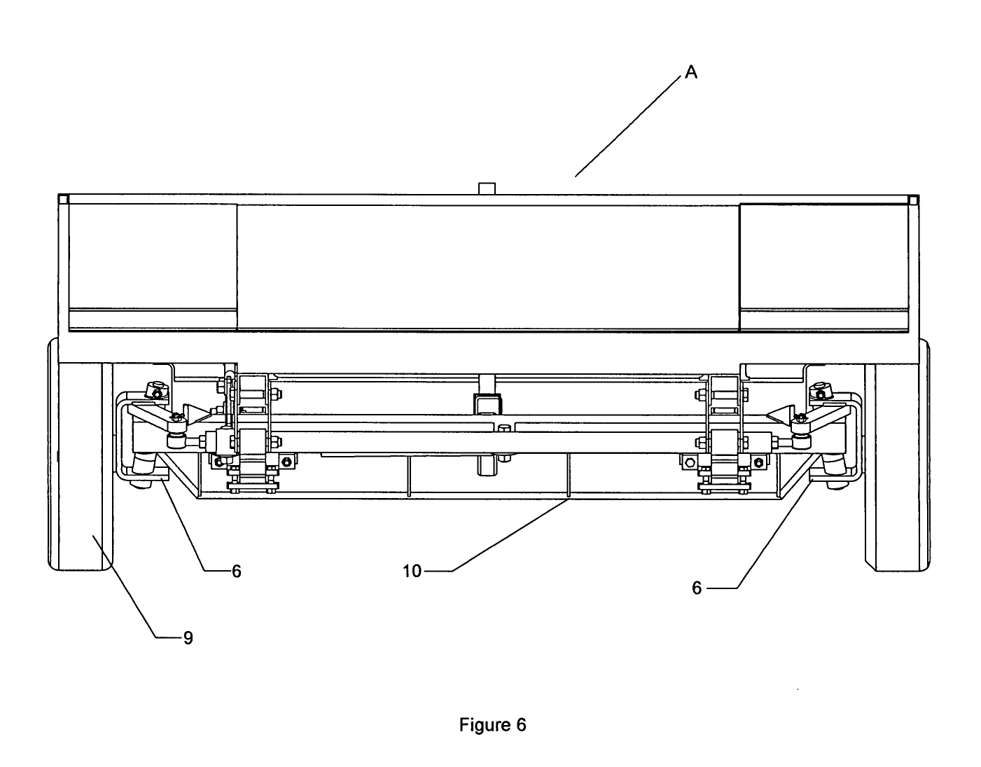

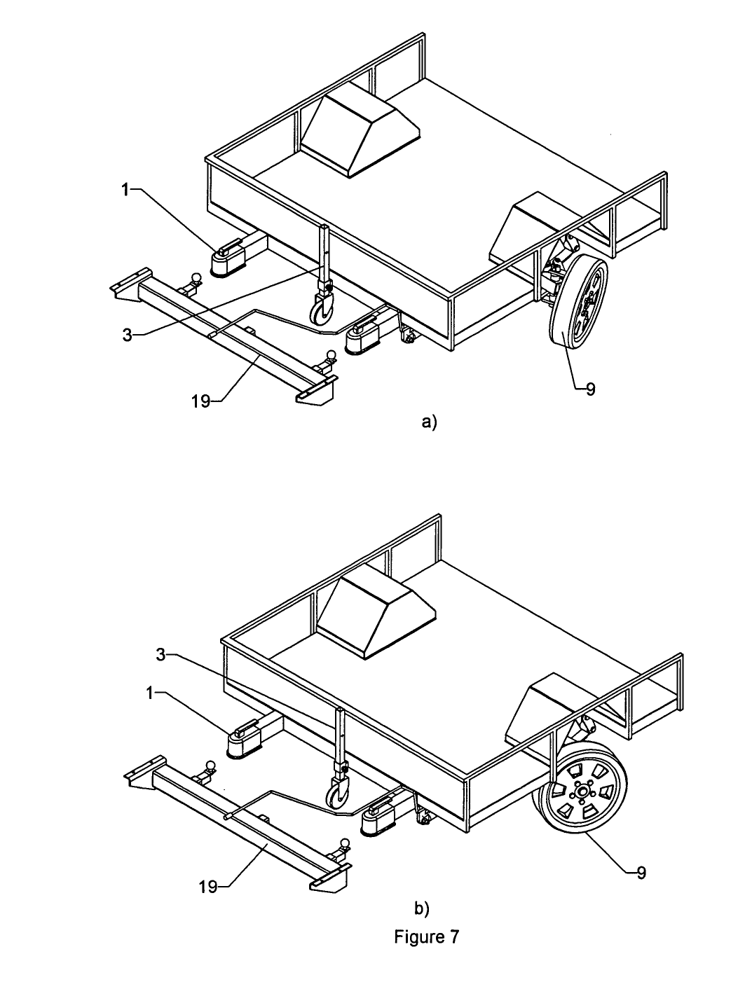

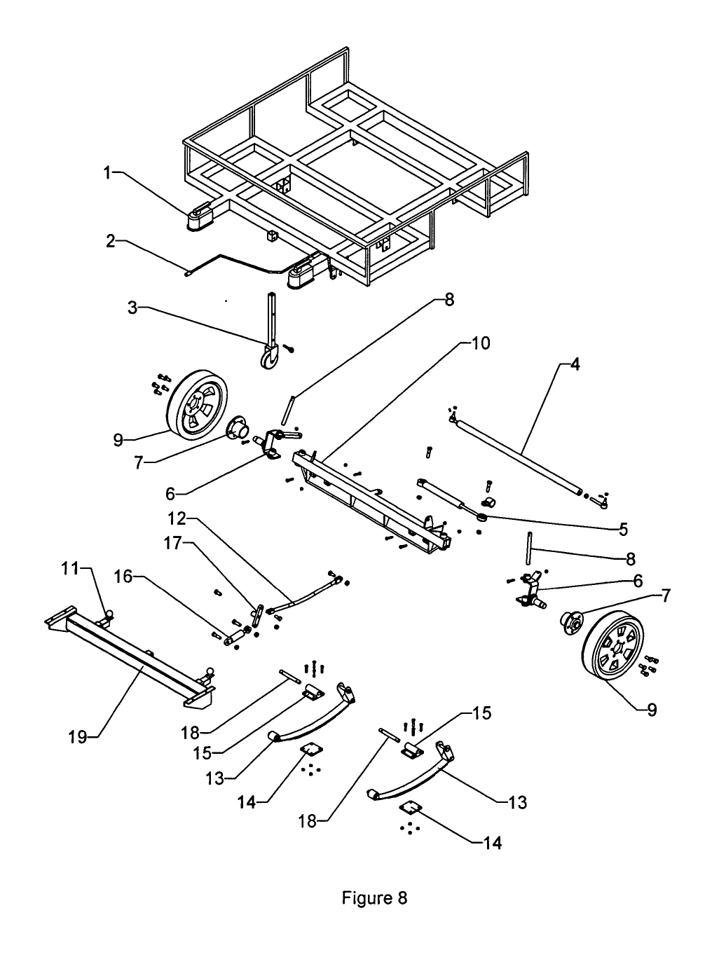

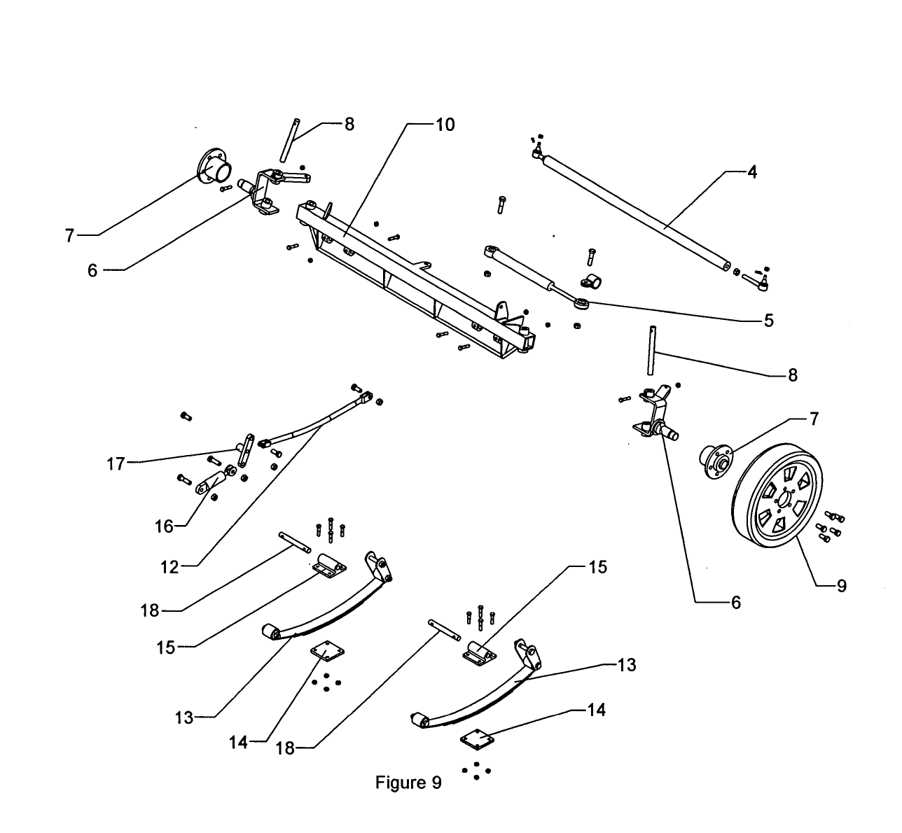

With reference to FIGS. 1 to 10b, there is illustrated a trailer (A) including two directional wheels (9), a cable (2) mounted to the structure of a tow bar (19) and connected to an electric motor (16) for activating a longer part member (12) making turn the directional wheels (9), which the longer part member (12) is joined to the electric motor (16) by a smaller part member (17), and which are connected by the use of bolts and nuts.

A wheel support (3) is mounted approximately in a middle of a front structure of the trailer (A).

An elongated rod (4) is provided of a fastening means at each end for connecting a camber angle (6) that is engaged to a caster connected to a directional wheel (9), and which each camber angle is also connected to a central part member (10) by the use of a smaller connecting rod (8).

A chock absorber (5) is connected at one end of the elongated rod (4) by the use of bolts and nuts, or other conventional fastenings means to the central part member (10), which prevents the vibration movement of the elongated rod (4) connected to the cambers angle (6).

Two leaf springs (13) are mounted to the structure of the trailer (A), which a center portion of each leaf spring is maintained by a plate (14) and a part member (15) that are connected by the use of bolts and nuts, and which are joined to the central part member (10) by a connecting rod (18) allowing the movement of each leaf spring (13).

Although only a single embodiment of the present invention has been described and illustrated, the present invention is not limited to the features of this embodiment, but includes all variations and modifications within the scope of claims.

1. A steerable trailer assembly, which comprising:
two directional wheels;
a cable mounted to the structure of a tow bar and connected to an electric motor for activating a longer part member making turn said directional wheels,
wherein said longer part member is joined to said electric motor by a smaller part member, and which are connected by the use of bolts and nuts;
a wheel support mounted approximately in a middle of a front structure of the trailer;
an elongated rod provided of a fastening means at each end for connecting a camber angle that is engaged to a caster connected to a directional wheel, and which each said camber angle is also connected to a central part member by the use of a smaller connecting rod;
a chock absorber connected at one end of said elongated rod by the use of bolts and nuts, or other conventional fastenings means to said central part member, which prevents the vibration movement of said elongated rod connected to said cambers angle; and
two leaf springs mounted to the structure of the trailer, which a center portion of each said leaf spring is maintained by a plate and a part member that are connected by the use of bolts and nuts, and which are joined to said central part member by a connecting rod allowing the movement of each said leaf spring.
